(19) United States
(12) Patent Application Publication
(10) Pub. No.: US 2017/0203364 A1
(43) Pub. Date: Jul. 20, 2017

(54) ADDITIVE MANUFACTURING WITH LASER AND PLASMA

(71) Applicant: Applied Materials, Inc., Santa Clara, CA (US)

(72) Inventors: Kartik Ramaswamy, San Jose, CA (US); Anantha K. Subramani, San Jose, CA (US); Kasiraman Krishnan, Milpitas, CA (US); Jennifer Y. Sun, Mountain View, CA (US); Srinivas D. Nemani, Sunnyvale, CA (US); Thomas B. Brezoczky, Los Gatos, CA (US); Christopher A. Rowland, Rockport, MA (US); Simon Yavelberg, Cupertino, CA (US); Swaminathan Srinivasan, Pleasanton, CA (US); Nag B. Patibandla, Pleasanton, CA (US); Ellie Y. Yieh, San Jose, CA (US); Hou T. Ng, Campbell, CA (US)

(21) Appl. No.: 15/326,910

(22) PCT Filed: Jul. 16, 2015
(86) PCT No.: PCT/US2015/040803

§ 371 Date: Jan. 17, 2017

Related U.S. Application Data
(60) Provisional application No. 62/026,553, filed on Jul. 18, 2014.

(51) Int. Cl. B22F 3/105; B33Y 30/00; B33Y 50/02; B28B 1/00; B23K 26/70; B23K 10/02; B23K 10/00; B23K 26/342; B23K 26/00; B33Y 10/00; B22F 1/00

(52) U.S. Cl. CPC B22F 3/1055; B33Y 10/00; B33Y 30/00; B33Y 50/02; B28B 1/001; B22F 1/0003; B23K 10/027; B23K 10/006; B23K 26/342; B23K 26/0006; B23K 26/702; B22F 2003/1051; B22F 2003/1057; B22F 2202/13; B22F 2301/205; B22F 2998/10; B23K 2203/14

(57) ABSTRACT

An additive manufacturing system includes a platen, a feed material dispenser apparatus configured to deliver a feed material over the platen, a laser configured to produce a laser beam, a controller configured to direct the laser beam to locations specified by data stored in a computer-readable medium to cause the feed material to fuse, and a plasma source configured to produce ions that are directed to substantially the same location on the platen as the laser beam.

### CLAIM OF PRIORITY

This application claims priority under 35 USC §119(e) to U.S. patent application Ser. No. 62/026,553, filed on Jul. 18, 2014.

### TECHNICAL FIELD

This present invention relates to additive manufacturing, also known as 3D printing.

### BACKGROUND

Additive manufacturing (AM), also known as solid freeform fabrication or 3D printing, refers to any manufacturing process where three-dimensional objects are built up from raw material (generally powders, liquids, suspensions, or molten solids) in a series of two-dimensional layers or cross-sections. In contrast, traditional machining techniques involve subtractive processes and produce objects that are cut out of a stock material such as a block of wood, plastic or metal.

A variety of additive processes can be used in additive manufacturing. The various processes differ in the way layers are deposited to create the finished objects and in the materials that are compatible for use in each process. Some methods melt or soften material to produce layers, e.g., selective laser melting (SLM) or direct metal laser sintering (DMLS), selective laser sintering (SLS), fused deposition modeling (FDM), while others cure liquid materials using different technologies, e.g. stereolithography (SLA).

Sintering is a process of fusing small grains, e.g., powders, to create objects. Sintering usually involves heating a powder. When a powdered material is heated to a sufficient temperature in a sintering process, the atoms in the powder particles diffuse across the boundaries of the particles, fusing the particles together to form a solid piece. In contrast to melting, the powder used in sintering need not reach a liquid phase. As the sintering temperature does not have to reach the melting point of the material, sintering is often used for materials with high melting points such as tungsten and molybdenum.

Both sintering and melting can be used in additive manufacturing. The material being used determines which process occurs. An amorphous solid, such as acrylonitrile butadiene styrene (ABS), is actually a supercooled viscous liquid, and does not actually melt; as melting involves a phase transition from a solid to a liquid state. Thus, selective laser sintering (SLS) is the relevant process for ABS, while selective laser melting (SLM) is used for crystalline and semi-crystalline materials such as nylon and metals, which have a discrete melting/freezing temperature and undergo melting during the SLM process.

Conventional systems that use a laser beam as the energy source for sintering or melting a powdered material typically direct the laser beam on a selected point in a layer of the powdered material and selectively raster scan the laser beam to locations across the layer. Once all the selected locations on the first layer are sintered or melted, a new layer of powdered material is deposited on top of the completed layer and the process is repeated layer by layer until the desired object is produced.

An electron beam can also be used as the energy source to cause sintering or melting in a material. Once again, the electron beam is raster scanned across the layer to complete the processing of a particular layer.

### SUMMARY

In one aspect, an additive manufacturing system includes a platen, a feed material dispenser apparatus configured to deliver a feed material over the platen, a laser configured to produce a laser beam, a controller configured to cause the laser beam to fuse the feed material at locations specified by data stored in a computer-readable medium, and a plasma source configured to produce ions that are directed to substantially the same location on the platen as the laser beam.

Implementations may include one or more of the following features. The laser source and the plasma source may be integrated in a coaxial point laser and plasma source configured such that the laser beam and the ions emerge from the coaxial point laser and plasma source along a common axis. The coaxial point laser and plasma source may be configured such that the laser beam and the ions emerge in an overlapping region. A heat source configured to apply heat to feed material on the platen from a side of the feed material farther from the plasma source.

A drive system may be configured to raster scan the laser beam across the platen, and the controller may be configured to control a power of the laser beam at a location on the platen to determine if the feed material at the location fuses. A drive system may be configured to translate the platen in a plane parallel to a surface of the platen so that the feed material at locations on the platen is fused by the laser beam according to data stored in the computer-readable medium. A voltage source may be electrically connected to the platen to maintain the platen at a first electrical potential to accelerate ions into the feed material.

The plasma source may include a conduit having a first end closer to the laser source and a second end closer to the platen, and the laser may be positioned to direct the laser beam through the conduit. A window at the first end of the conduit may permit passage of the laser and block escape of the ions. A gas source may be configured to inject a gas into the first end of the conduit. At least the second end of the conduit may be conductive, and the plasma source may include a voltage source connected to the conductive second end of the conduit and configured to apply a voltage sufficient to generate a plasma between the second end of the conduit and the platen. The conduit may be conductive. A pair of electrodes may be positioned within the conduit, and the plasma source may include a voltage source connected to the pair of electrodes and configured to apply a voltage sufficient to generate a plasma within the conduit. The conduit may include an inner tube and an outer tube surrounding the inner tube, and the inner tube may be electrically connected to the outer tube at the first end of the conduit.

In another aspect, a method of additive manufacturing includes dispensing a layer of feed material over a platen, directing a laser beam to heat the feed material at locations specified by data stored in a computer-readable medium, and directing ionized gas to substantially the same location on the platen as the laser beam.

Implementations may include one or more of the following features. The laser beam and the ionized gas may be directed along a common axis. The laser beam may be raster scanned across the platen and a power of the laser beam may be controlled at a location on the platen to determine if the feed material at the location fuses. A source of the ionized gas may be raster scanned across the platen. The flow of ionized gas from the source may be controlled to control a chemical composition of the feed material within the layer of the feed material. The composition of ionized gas from the source may be controlled to control a chemical composition of the feed material within the layer of the feed material. The ionized gas may be a reactive gas. The ionized gas may be directed at a region of the layer of feed material corresponding to a surface of an object being fabricated to form a coating of different composition on the object.

Implementations can provide one or more of the following advantages. The chemical composition for all voxels in an additively manufactured object can be selectively controlled (xyz control). Surface finish can be improved or modified concurrently with the fusing of feed material to yield the finished part. Additive and subtractive manufacturing can be sequentially carried out using the same apparatus.

The details of one or more embodiments of the invention are set forth in the accompanying drawings and the description below. Other aspects, features, and advantages of the invention will be apparent from the description and drawings, and from the claims.

### DESCRIPTION OF DRAWINGS

FIG. 1A is a schematic view of an additive manufacturing system.

FIG. 1B is a schematic view of an additive manufacturing system.

FIG. 1C is a schematic view of system incorporating a nozzle.

FIG. 2A is a schematic view of a point dispenser.

FIG. 2B is a schematic view of a line dispenser.

FIG. 2C is a schematic view of an array dispenser.

FIG. 2D is a schematic of a through-silicon-via in two different modes of operation.

FIG. 3A shows different fused feed material having features of varying resolution.

FIG. 3B shows a schematic view of a layer of a feed material.

FIG. 3C shows a schematic view of an additive manufacturing system.

Like reference symbols in the various drawings indicate like elements.

### DETAILED DESCRIPTION

It would be desirable to manufacture a part by 3D printing in which the material composition of the part varies spatially through the part, e.g., within a single deposited layer. Conceptually, different feed materials could be deposited in different portions of the part. However, for some manufacturing situations this may not be practical, or additional degrees of freedom in variation of material composition may be desired. The methods and apparatus disclosed herein allow chemical modification and/or adjustment of surface finish to occur for each layer of deposited feed material during one or more steps of the additive manufacturing process. In contrast, conventional systems which use energy from, for example, laser sources, cause feed material to fuse, for example, by changing a phase, or by melting and re-solidifying of feed material, without any chemical reactions.

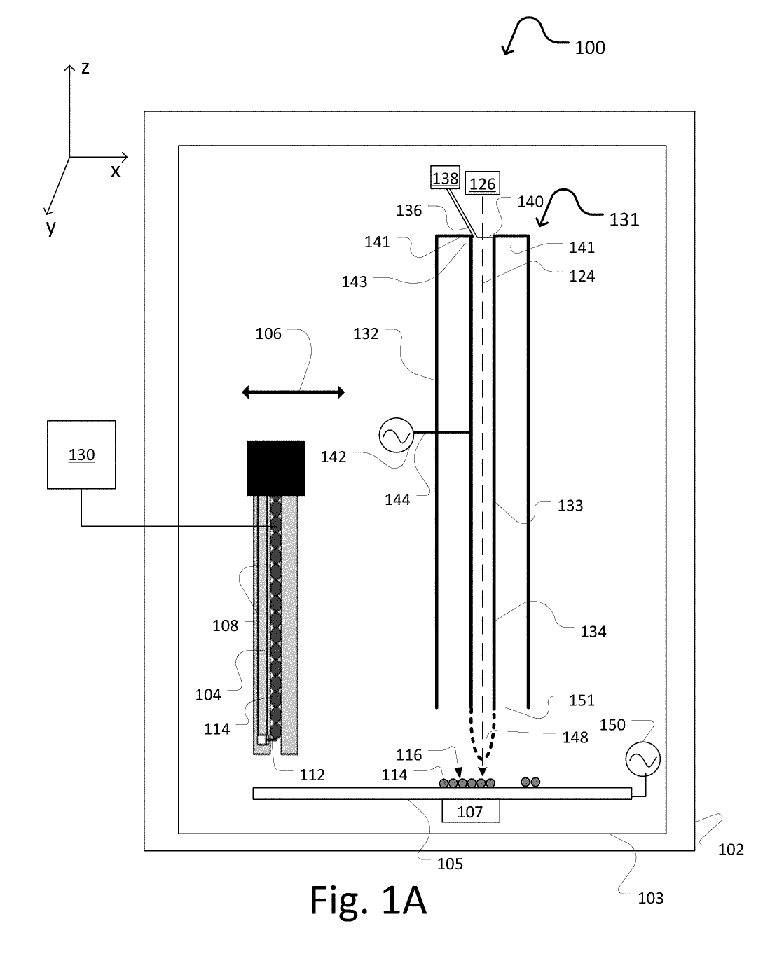

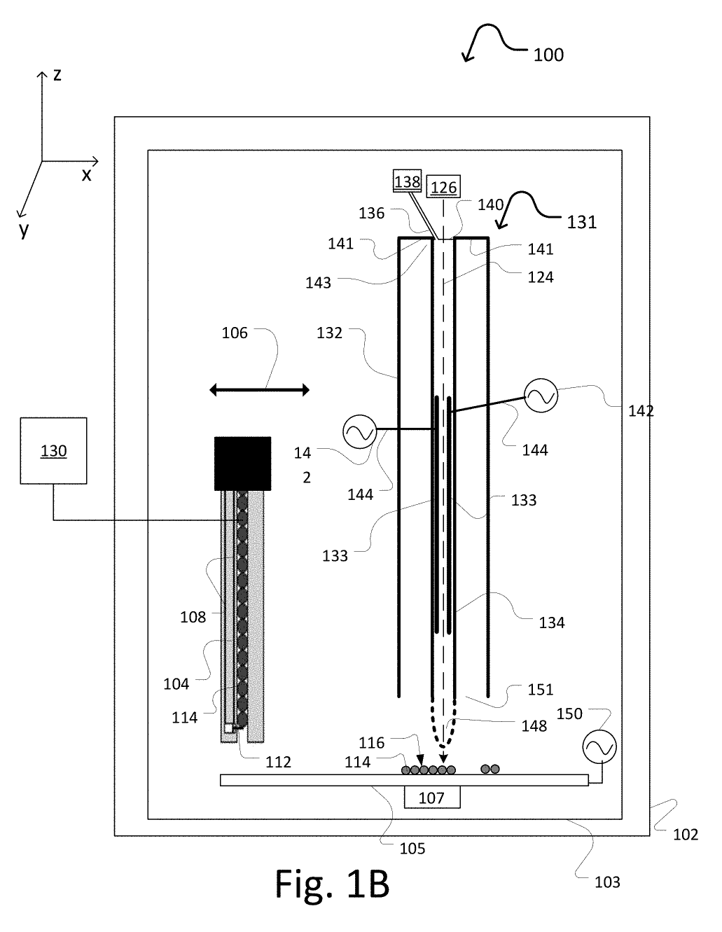

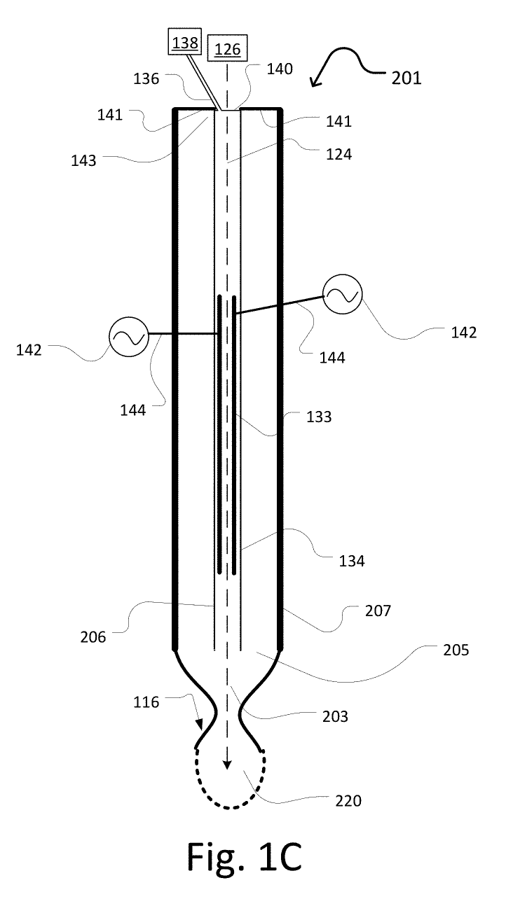

FIG. 1A shows a schematic of an exemplary additive manufacturing system 100. The system 100 includes and is enclosed by a housing 102. The housing 102 can, for example, allow a vacuum environment to be maintained in a chamber 103 inside the housing, but alternatively the interior of the chamber 103 can be a substantially pure gas or mixture of gases, e.g., a gas or mixture of gases that has been filtered to remove particulates, or the chamber can be vented to atmosphere. The vacuum environment or the filtered gas can reduce defects during manufacture of a part. For some implementations, the chamber 103 can be maintained at a positive pressure, i.e., above atmospheric pressure. This can help prevent the external atmosphere from entering the chamber 103.

The additive manufacturing system 100 includes a dispenser to deliver a layer of powder over a platen 105, e.g., on the platen or onto an underlying layer on the platen.

A vertical position of the platen 105 can be controlled by a piston 107. After each layer of powder has been dispensed and fused, the piston 107 can lower the platen 120 and any layers of powder thereon, by the thickness of one layer, so that the assembly is ready to receive a new layer of powder.

The platen 105 can be sufficiently large to accommodate fabrication of large-scale industrial parts. For example, the platen 105 can be at least 500 mm across, e.g., 500 mm by 500 mm square. For example, the platen can be at least 1 meter across, e.g., 1 meter square.

In some implementations, the dispenser can include a material dispenser assembly 104 positionable above the platen 105. The dispenser assembly 104 can include an opening through which feed material is delivered, e.g., by gravity, over the platen 105. For example, the dispenser assembly 104 can includes a reservoir 108 to hold feed material 114. Release of the feed material 114 is controlled by a gate 112. Electronic control signals are sent to the gate 112 to dispense the feed material when the dispenser is translated to a position specified by the CAD-compatible file.

The gate 112 of the dispenser assembly 104 can be provided by a piezoelectric printhead, and/or one or more of pneumatic valves, microelectromechanical systems (MEMS) valves, solenoid valves, or magnetic valves, to control the release of feed material from the dispenser assembly 104. The higher the spatial resolution of the voxels, the smaller the volume of the voxels and thus the lower the quantity of feed material that would be dispensed per voxel.

Alternatively, the dispenser can include a reservoir positioned adjacent the platen 105, and a roller that is moved horizontally (parallel to the surface of the platen) to push the feed material from the reservoir and across the platen 105.

A controller 130 controls a drive system (not shown), e.g., a linear actuator, connected to the dispenser assembly 104 or roller. The drive system is configured such that, during operation, the dispenser assembly or roller is movable back and forth parallel to the top surface of the platen 105 (along the direction indicated by arrow 106). For example, the dispenser assembly 104 or roller can be supported on a rail that extends across the chamber 103. Alternatively, the dispenser assembly 104 or roller could be held in a fixed position, while the platen 105 is moved by the drive system.

In the case of a dispenser assembly 104 that includes an opening through which feed material is delivered, as the dispenser assembly 104 scans across the platen, the dispenser assembly 104 can deposit feed material at an appropriate location on the platen 105 according to a printing pattern that can be stored in non-transitory computer-readable medium. For example, the printing pattern can be stored as a file, e.g., a computer aided design (CAD)-compatible file, that is then read by a processor associated with the controller 130. Electronic control signals are then sent to the gates 112 to dispense the feed material when the dispenser is translated to a position specified by the CAD-compatible file.

In some implementations, the dispenser assembly 104 includes a plurality of openings through which feed material can be dispensed. Each opening can have an independently controllable gate, so that delivery of the feed material through each opening can be independently controlled.

In some implementations, the plurality of openings extend across the width of the platen, e.g., in direction perpendicular to the direction of travel 106 of the dispenser assembly 104. In this case, in operation, the dispenser assembly 104 can scan across the platen 105 in a single sweep in the direction 106. In some implementations, for alternating layers the dispenser assembly 104 can scan across the platen 105 in alternating directions, e.g., a first sweep in the direction 106 and a second sweep in the opposite direction.

Alternatively, e.g., where the plurality of openings do not extend across the width of the platen, the dispensing system 104 can be configured such that the dispenser assembly 104 moves in two directions to scan across the platen 105, e.g., a raster scan across the platen 105, to deliver the material for a layer.

Alternatively, the dispenser assembly 104 can simply deposit a uniform layer of feed material over the platen. In this case, neither independent control of individual openings nor a printing pattern stored in non-transitory computer-readable medium is needed.

Optionally, more than one feed material can be provided by the dispenser assembly 104. In such a case, each feed material can be stored in a separate reservoir having its own control gate and be individually controlled to release respective feed material at locations on the platen 105 as specified by the CAD file. In this way, two or more different chemical substance can be used to produce an additively manufactured part.

The feed material can be dry powders of metallic or ceramic particles, metallic or ceramic powders in liquid suspension, or a slurry suspension of a material. For example, for a dispenser that uses a piezoelectric printhead, the feed material would typically be particles in a liquid suspension. For example, the dispenser assembly 104 can deliver powder in a carrier fluid, e.g. a high vapor pressure carrier, e.g., Isopropyl Alcohol (IPA), ethanol, or N-Methyl-2-pyrrolidone (NMP), to form the layers of powder material. The carrier fluid can evaporate prior to the sintering step for the layer. Alternatively, a dry dispensing mechanism, e.g., an array of nozzles assisted by ultrasonic agitation and pressurized inert gas, can be employed to dispense the first particles.

Examples of metallic particles include metals, alloys and intermetallic alloys. Examples of materials for the metallic particles include titanium, stainless steel, nickel, cobalt, chromium, vanadium, and various alloys or intermetallic alloys of these metals. Examples of ceramic materials include metal oxide, such as ceria, alumina, silica, aluminum nitride, silicon nitride, silicon carbide, or a combination of these materials.

Optionally, the system 100 can include a compaction and/or levelling mechanism to compact and/or smooth the layer of feed materials deposited over the platen 105. For example, the system can include a roller or blade that is movable parallel to the platen surface by a drive system, e.g., a linear actuator. The height of the roller or blade relative to the platen 105 is set to compact and/or smooth the outermost layer of feed material. The roller can rotate as it translates across the platen.

During manufacturing, layers of feed materials are progressively deposited and sintered or melted. For example, the feed material 114 is dispensed from the dispenser assembly 104 to form a layer 116 that contacts the platen 105. Subsequently deposited layers of feed material can form additional layers, each of which is supported on an underlying layer.

After each layer is deposited, the outermost layer is processed to cause at least some of the layer to fuse, e.g., by sintering or by melting and resolidifying. Regions of feed material that are not fused in a layer can serve to support portions of an overlying layer.

The system 100 includes a heat source configured to supply sufficient heat to the layer of feed material to cause the powder to fuse. Where the feed material is dispensed in a pattern, the power source can heat the entire layer simultaneously, e.g., after treatment by gas or ions as discussed below. For example, the power source could be a lamp array positioned above the platen 105 that radiatively heats the layer of feed material. Alternatively, if the feed material is deposited uniformly on the platen 105, the power source can be configured to heat locations specified by a printing pattern stored in a computer-readable medium, e.g., as a computer aided design (CAD)-compatible file, to cause fusing of the powder at the locations.

For example, the heat source can be a laser source 126 to generate a laser beam 124. The laser beam 124 from a laser source 126 is directed to locations specified by the printing pattern. For example, the laser beam 124 is raster scanned across the platen 105, with laser power being controlled at each location to determine whether a particular voxel fuses or not. The laser beam 124 can also scan across locations specified by the CAD file to selectively fuse the feed material at those locations. To provide scanning of the laser beam 124 across the platen 105, the platen 105 can remain stationary while the laser beam 124 is horizontally displaced. Alternatively, the laser beam 124 can remain stationary while the platen 105 is horizontally displaced.

The laser beam 124 from the laser source 126 is configured to raise the temperature of a region of feed material that is irradiated by the laser beam. In some embodiments, the region of feed material is directly below the laser beam 124.

The platen 105 can additionally be heated by a heater, e.g., by a heater embedded in the platen 105, to a base temperature that is below the fusing point of the feed material. In this way, the laser beam 124 can be configured to provide a smaller temperature increase to fuse the deposited feed material. Transitioning through a small temperature difference can enable the feed material to be processed more quickly. For example, the base temperature of the platen 105 can be about 1500° C. and the laser beam 124 can cause a temperature increase of about 50° C.

The laser beam 124 from the laser source 126 can be incorporated into a laser and ion source 131. The laser and ion source 131 is configured such that ions from a plasma 148 are directed to substantially the same spot on the platen 105 as the laser beam 124.

In some implementations, the laser and ion source 131 is a coaxial point laser and plasma source 131a. That is, the laser beam 124 and the plasma 148 emerge from the source 131a along a common axis. In such embodiments, when the laser beam 124 is scanned and directed to locations specified by a printing pattern stored as a computer aided design (CAD)-compatible file to fuse the feed material, the plasma 148 can be concurrently directed and delivered to the same location on the platen. In some implementations, the laser beam 124 and the plasma 148 can be overlapping in the horizontal plane.

The laser and ion source 131 and/or the platen 105 can be coupled to an actuator assembly, e.g., a pair of linear actuators configured to provide motion in perpendicular directions, so as to provide relative motion between the laser and ion source 131 and/or the platen 105. The controller 130 can be connected to the actuator assembly to cause the laser beam 124 and plasma 148 to be scanned across the layer of feed material.

The coaxial point plasma source 131a can include a conduit 135, e.g., a tube through which both the laser beam 124 and the gas that provides the plasma propagate. For example, the coaxial point plasma source 131a can include a hollow outer conductor 132 having a first diameter and a hollow inner conductor 134 having a second diameter smaller than the first diameter. The hollow inner conductor is placed within the hollow outer conductor. In some implementations, the hollow inner conductor 134 extends closer to the platen than the hollow outer conductor 132. However, in some implementations, the system uses only a single tube.

The laser beam 124 can propagate through the conduit 135, e.g., through the hollow interior of the inner conductor 134, toward a surface of the platen 105. A gas source 138 supplies gas to the hollow interior of the inner conductor 134 via a gas delivery system 136. The gas delivery system 136 includes valves that are controlled by the controller 130 for the release of gases from the gas source 138 into the inner conductor 134. Examples of gases include nitrogen, argon, helium, oxygen, and titanium fluoride (TiₓF_{y}).

An end 143 of the conduit 135, e.g., of inner conductor 134, that is farther from the platen 105 is terminated by a window 140 that is transparent to a wavelength of laser beam 124. The window 140 helps to retain the gas within the inner conductor 134. The laser beam 124 can propagate from the laser source 126 through the window 140 into the inner conductor 134. In some implementations, the gas delivery system 136 supplies gas to through an inlet in the window 140. In some implementations, the gas delivery system 136 supplies gas to through an inlet in a side of the tube.

In some implementations, the inner conductor 134 is electrically coupled to the outer conductor 132. For example, conductor plates 141 can electrically connect the hollow outer conductor 132 to the hollow inner conductor 134. The conductor plates 141 can be located at the end 143 of the conduit farther from the platen 105.

An alternating current (AC) (e.g., radiofrequency or microwave radiation) power source 142 delivers an electric field via electrical connections 144 to the conduit 135, e.g., outer conductor 132 and/or the inner conductor 134 and/or any electrodes that may be present in the conduit 135. An electrical connection between the AC power source 142 and the conduit 135 can be provided at a distance away from the shorted end 143 of the coaxial point plasma source 131a. FIG. 1B shows two separate power sources 142, each being connected via electrical connections 144 to the electrode and counter-electrode 133. FIG. 1A shows two separate power sources 142 and 150, with a first power source 142 connected to the conduit 135 and a second power source 150 connected to the platen 105.

The end of the conduit 135, e.g., the outer conductor 132, closer to the platen 105 can be open or can be closed except for an aperture that would permit the gas and the laser beam 124 to pass through toward the platen 105. In some implementations, the end opposite the shorted end of the coaxial point plasma source with the conductor plates 141 is an open end 151. The open end 151 can be an end portion of the conduit 135 (e.g., hollow outer conductor 132) that is not mechanically connected to the hollow inner conductor 134. In some implementations, a plasma 148 can be generated in the conduit 135, as described below). In some implementations, the plasma can be generated at the open end 151. In such embodiments, the electric field of a sufficient magnitude can be applied to the outer conductor 132 and the inner conductor 134 to generate a plasma from the neutral gas supplied by the gas source 138.

A plasma is an electrically neutral medium of positive and negative particles (i.e. the overall charge of a plasma is roughly zero). For example, when nitrogen gas is supplied from the gas source 138, it becomes ionized to produce N₂⁺or N⁺. These positive ions and electrons produced from the ionization form the plasma 148. The plasma 148 exits the coaxial point plasma source 131a to contact feed material 114 deposited on the platen 105.

For the implementation shown in FIG. 1A, a region of plasma is produced around the conductors 132 and 134 at the open end when a current flows from either conductors, held at a high potential, into the neutral gas supplied by the gas source 138. In some implementations, an electric field is generated between the platen 105 and the end of the conduit 135, and the plasma 148 is generated as the gas exits the conduit 135. In such implementations, at least an open end 151 of the conduit 135, e.g., the end of the inner conductor 134, closer to the platen functions as one of the electrodes and the platen 105 serves as a counter-electrode. As noted above, the inner conductor 134 and outer conductor 132 can be electrically connected so as to be at the same electric potential. However, if the outer conductor 132 is not electrically connected to the inner connector 134, then the outer conductor 132 can be floating or connected to ground. In implementations where the outer conductor 132 is not electrically connected to the inner connector 134 and the inner conductor 134 is shorter than the outer conductor 132, the outer conductor 132 can serve as the electrode 133.

In implementations where the plasma is generated in the conduit 135, the conduit 135 can include one or more electrodes 133 to ionize the gas as it flows through or out of the conduit. In such implementations, the electrodes 133 (e.g., an electrode and a counter electrode) can be positioned inside the conduit 135 (see FIG. 1B). In this case, one or both of the electrodes 133 can be positioned in the conduit 135 but spaced apart from inner surface of the inner conductor 134.

In some implementations, rather than being a conductor, the conduit 135 can be formed of a dielectric material. In this case, one or more of the electrodes 133 can be disposed at the open end 151 or on an inner surface of the conduit 135.

In some implementations, the gas source 138 can include electrodes and ionize the gas before it is delivered through the gas delivery system 136 into the inner conductor 134.

The outer conductor 132 and the inner conductor 134 can be made of metals. The conductors 132 and 134 can be made of the same metals or different metals. In general, by applying an RF signal of appropriate power and frequency to the conduit 135 and/or the platen 105 and/or electrodes placed within the conduit 135, a plasma 148 derived from the gas supplied by the gas source 138 can be formed.

A higher radio frequency drive voltage is applied to one electrode can control a flux of the ions in the plasma while a lower radio frequency drive voltage applied to a counter-electrode can control an energy of the ions in the plasma.

An RF bias can be provided to the platen 105 by RF source 150 to form a sheath, which is a boundary layer of charge, around the feed material 114. The boundary layer of charge can attract oppositely charged ions from the plasma. When the ions impinge the feed material, the ions can cause chemical reactions on the fused feed material. The chemical modification of the feed material can occur concurrently with the fusing of the feed material by the laser beam 124.

As an example, the feed material 114 may be titanium. Titanium nitride is generally a harder material than titanium. It may be desirable for certain regions of the additively manufactured part to have a hard surface, for example, by being formed of titanium nitride. In this case, nitrogen can be supplied by the gas source 138 to produce a plasma that may include nitrogen radicals in addition to nitrogen ions N₂⁺ or N⁺. These nitrogen species react locally with titanium to form titanium nitride at room temperature or slightly elevated temperatures (e.g., room temperature to 300° C.).

The ions can be applied to portions of the feed layer corresponding to the surface of the body being fabricated. This permits generation of a coating on the surface of the body. For example, a titanium part would be coated with a TiN coating.

In addition or as an alternative to causing chemical reactions of the feed material, etchant radicals, such as TiₓF_{y} can be used to improve surface finish of the fused feed material. The etchant radicals can be derived from a second gas source, which is interfaced to the coaxial point laser and plasma source, by a second gas inlet. The controller 130 is coupled to a valve for each gas source to control which gas flows into the conduit 135 in response to instructions from the CAD program. For example, the etchant radials can adjust the surface roughness of the fused feed material. For example, the etchant radicals can generate a surface having 30-100 microinches of surface roughness. The use of etchant radicals help to remove a small amount of fused feed material to leave a surface that has a lower surface roughness.

Alternatively, by adjusting a density of the ions striking the surface of the fused feed material, the surface roughness of the fused feed material can be increased, for example, when the etchant randomly removes material to leave a pitted surface having an increased roughness. For example, by changing the frequency of the RF voltage applied to the outer conductor 132, inner conductor 134, and/or the electrodes 133, a flux of the plasma can be decreased such that fewer ions strike the surface of the fused feed material, causing irregularities on the surface that are spaced further apart, increasing surface roughness. Increased surface roughness of the fused feed material may improve the stickiness or adhesion of a new layer of feed material deposited on top of the fused feed material.

In some implementations, ions in the plasma formed near the open end 151 can travel to the platen 105 without further acceleration or guidance.

In some implementations, an additional device can be incorporated before the platen to help accelerate a flow of gas (e.g., ions in the plasma) as it exits through the inner conductor.

For example, as shown in FIG. 1C, a coaxial laser and gas source 201 is similar to the coaxial point laser and plasma source 131a, with a laser source 126 and a gas source 138, and the laser beam 124 and gas emerging from the source 201 along a common axis. Ionization of the gas from the gas source 138 is optional, but can be accomplished in the same manner as discussed above for the coaxial laser and plasma source 131a.

The coaxial laser and gas source 201 also includes a device, such as a nozzle 203 at an open end 205 of the outer conductor 207 and the inner conductor 209 nearer the platen 105. The nozzle 203 is configured to accelerate flow of the gas as it exits the inner conductor 206. In some implementations, the nozzle is configured to induce supersonic flow of the gas. For example, the nozzle 203 can be a de Laval nozzle, convergent-divergent nozzle, CD nozzle, or con-di nozzle. In some implementations, the de Laval nozzle 203 can be a tube that is pinched in the middle to have a carefully balanced, asymmetric hourglass-shape. The nozzle 203 is used to accelerate a particle beam 220, for example, of ions passing through it to obtain a larger axial velocity. In this way, the kinetic energy of the particle beam causes removal of material at the surface, e.g., surface polishing, of the layer of the additively manufactured part concurrently as the region is being fused by the laser beam.

The resolution of the laser and plasma source 131 and/or laser and gas source 201 may be millimeters, down to microns. In other words, chemical reactions of the feed material can be localized to a few millimeters of the additively manufactured part, thus providing excellent spatial control of the chemical composition of the manufactured part. The chemical reactions of the feed material can be controlled, e.g., by adjusting the flow rate or the composition of the gas, or by controlling the applied voltage to control the kinetic energy of the ions. This adjustment can be performed as the combined laser and plasma source 131 scans across the platen 105, thus providing within-layer control of the feed material chemistry. In addition, since the laser source 126 can be controlled independently of the gas and/or plasma, not all regions fused by the laser 124 need be treated by the gas or ions, and gas or ions can be applied to regions that are not fused by the laser 124.

As discussed above, an RF bias can be applied on the platen to accelerate charged ions onto the fused material part. In this way, ions may penetrate the fused material part to cause or relieve stress created by thermal annealing of the feed material (caused by the laser beam 124). In general, neutral molecules such as argon, or helium, can be used for surface polishing without causing any chemical modification of the surface. When such neutral molecules are used, the RF power sources 142 can be turned off, and the neutral molecules from the gas supply 138 can simply accelerate through the de Laval nozzle 203 before they strike a surface of the fused feed material. When neutral molecules are used, diffusion of these (or other) molecules into the layer of feed material that is being fused can occur even without a bias being applied to the platen. For example, the molecules may diffuse directly into the layer of hot fused feed material, produced by laser fusing/sintering.

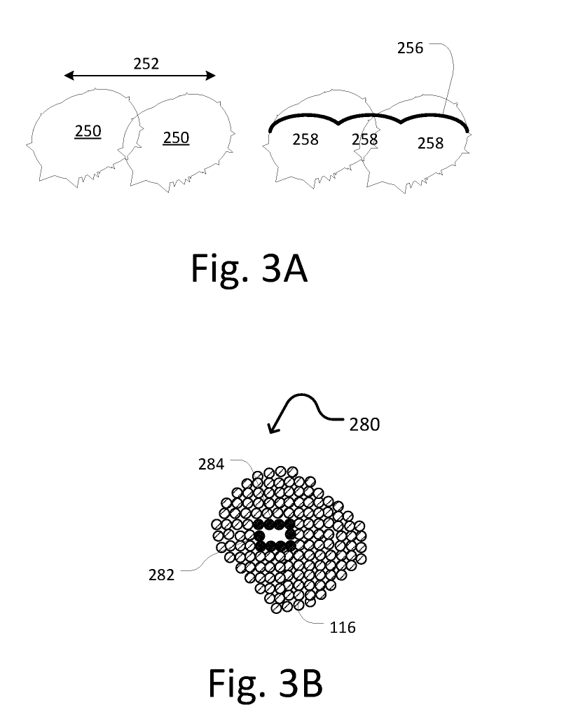

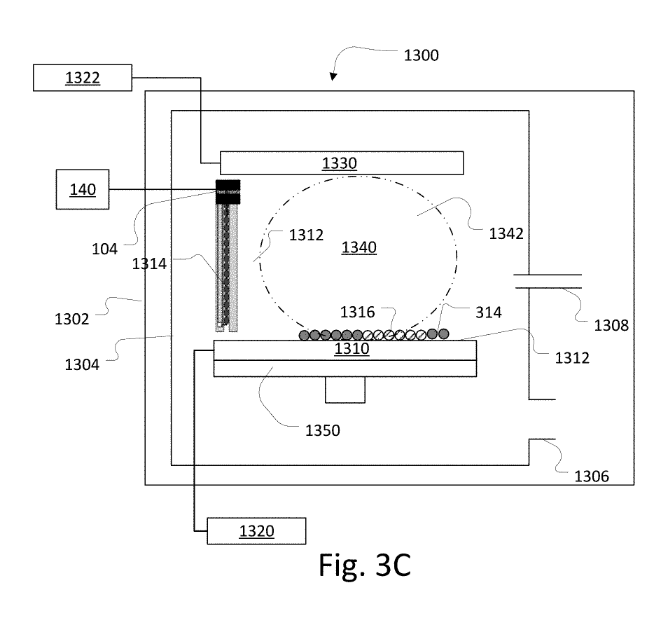

The above described capabilities are especially suitable for use in modifying a chemical composition and/or a surface finish of an inner surface of an additively manufactured conduit. For example, FIG. 3B shows a top view of a layer 280 of feed material that constitutes one layer of an additively manufactured conduit. The conduit has an inner wall 282. The inner wall 282 may be made of a material 284 obtained by chemically modifying the original feed material 114. The ease with which the inner wall 322 may be chemically modified during the additively manufacturing process is one advantage of the methods described above.

In some implementations, the controller 130 can be used to control the gas delivery system 136 to adjust a gas flow rate or gas composition entering a gas inlet of the conduit 135. In some implementations, the controller 130 can be used to adjust the voltage applied to the electrodes 133 and/or the platen 105. The adjustments can be made in conjunction with a position (x-y position) of the laser beam on a particular layer (Z position) of feed material. In this way, the desired chemical composition of the fabricated part can vary as a function of lateral (x-y) position within a particular feed layer.

For example, the laser and plasma source 131 can include additional gas inlets connected to respective additional gas sources in order to deliver more than one type of gas to the laser and plasma source 131. In this way, for example, a certain x-y position of the feed material may be oxidized when a flow of oxygen is delivered through the laser and plasma source 131 to that position in the layer of feed material.

As an example, if the feed material is titanium, particular locations on the layer of feed material can react with the oxygen to form titanium oxide. The flow of oxygen can be stopped, and a flow of nitrogen can be initiated to produce titanium nitride at another location in the layer of feed material.

In addition to chemically modifying the surface or changing a surface roughness of the additively manufactured part, the point plasma source can also be used for subtractive manufacturing by removing portions of a manufactured part. In this way, the subtractive process can be used to improve resolution in the manufactured part. For example, as shown in FIG. 3A, the resolution of two adjacent “pixels” 250 of fused feed material is denoted by an arrow 252. As shown in FIG. 3A, subtractive processing can be used to create a new surface profile 256, in which a resolution of adjacent “pixel” 258 is now higher. Subtractive processing can be carried out chemically using an etchant like TiₓF_{y}, and/or it can be conducted using laser power that is sufficiently high to ablate the fused feed material. The subtractive processing can be performed on a layer after the additive processing has been performed. Thus, additive and subtractive manufacturing can be sequentially carried out on the same layer using the same apparatus.

In this way, the methods and apparatus allow full three dimensional (x, y, z) control of the chemical composition and surface roughness of all points within the additively manufactured part.

In operation, after each layer has been deposited and heat treated, the platen 105 is lowered by an amount substantially equal to the thickness of layer. Then the dispenser 104, which does not need to be translated in the vertical direction, scans horizontally across the platen to deposit a new layer that overlays the previously deposited layer, and the new layer can then be heat treated to fuse the feed material. This process can be repeated until the full 3-dimensional object is fabricated. The fused feed material derived by heat treatment of the feed material provides the additively manufactured object.

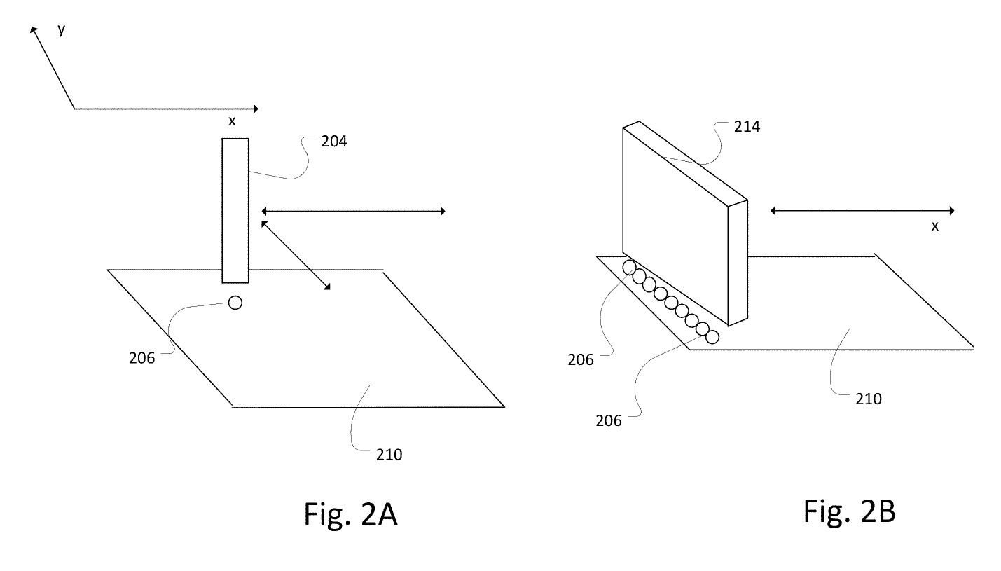

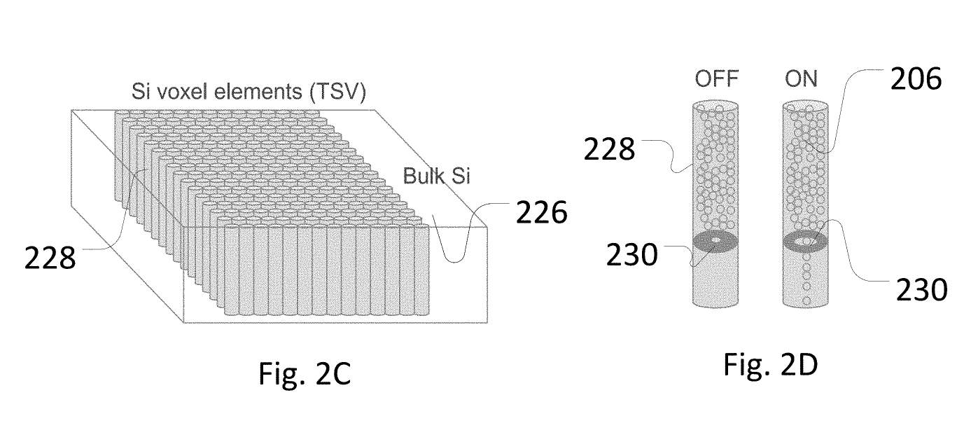

As shown in FIG. 2A, a dispenser 204, which could be used for the dispenser assembly 104, may be a single point dispenser, and the dispenser would be translated across the x and y direction of the platen 105 to deposit a complete layer of feed material 206 on the platen 105.

Alternatively, as shown in FIG. 2B, a dispenser 214, which could be used for the dispenser assembly 104, may be a line dispenser that extends across the width of the platen. For example, the dispenser 214 could include a linear array of individually controllable openings, e.g., nozzles. The dispenser 214 can be translated only along one dimension, e.g., substantially perpendicular to the long axis of the dispenser, to deposit a complete layer of feed material on the platen.

Alternatively, as shown in FIGS. 2C-2D, a dispenser 224, which could be used for the dispenser assembly 104, includes a two-dimensional array of individually controllable openings, e.g., nozzles. For example, the dispenser 224 can be a large area voxel nozzle print (LAVoN). LAVoN 224 allows a complete two dimensional layer of feed material to be deposited simultaneously. LAVoN 224 may be a dense grid of through-silicon via (TSV) 228 formed in bulk silicon 226. Each TSV 228 can be controlled by a piezoelectric gate 230 that closes an exit opening of a particular 228 when an appropriate voltage is applied such that the feed material 206 is retained within the TSV. When a different voltage is applied to the TSV 228, the piezoelectric gate 230 can open an exit opening of a particular TSV 228, allowing feed material to be deposited on a platen. Each of the TSV 228 in the LAVoN 224 is individually accessed by control signals produced from a controller based on a CAD-file that defines the fabricated object. LAVoN 224 can be used to deposit a single feed material only. In such a case, no feed material is deposited at regions of void in the fabricated object or in regions beyond the fabricate object. The embodiments shown in FIGS. 2B-2D would speed up the deposition process of the feed material on the platen.

Instead of the point plasma source shown in FIGS. 1A and 1B, a large area background plasma as shown can also be used to control chemical composition along a thickness (z) direction of the fabricated part. “Large area” indicates that the plasma can cover substantially the entire layer of feed material.

As shown in FIG. 3C, an additive manufacturing system 300 is similar to the additive manufacturing system 100 of FIG. 1A, but includes a large area background plasma generation system 302. The additive manufacturing system 300 includes chamber walls 304 that define the chamber 103.

A large area background plasma can be produced by the plasma generation system 302. The plasma generation system 302 includes an electrode 310, i.e., a first electrode. The electrode 310 can be a conductive layer on or in the platen 120. This permits the electrode 310 to can be translated vertically, similar to the piston 107 in FIG. 1A. The electrode 310 can serve as the cathode.

The additive manufacturing system 300 also includes a counter-electrode 330, i.e., as second electrode. The counter-electrode 330 can serve as an anode. Although FIG. 3C illustrates the counter-electrode 330 as a plate suspended in the chamber 103, the counter-electrode 330 could have other shapes or be provided by portions of the chamber walls 304.

At least one of the electrode 310 and/or counter-electrode 330 is connected to an RF power supply, e.g., an RF voltage source. For example, the electrode 310 can be connected to an RF power supply 312 and the counter-electrode can be connected to an RF power supply 332. In some implementations, one of the electrode 310 or counter-electrode 330 is connected to an RF power supply and the other of the electrode 310 or counter-electrode 330 is grounded or connected to an impedance matching network.

By application of an RF signal of appropriate power and frequency, a plasma 340 forms in a discharge space 342 between the cathode 310 and the anode 330. A plasma is an electrically neutral medium of positive and negative particles (i.e. the overall charge of a plasma is roughly zero). The plasma 340 is depicted as elliptical only for illustrative purposes. In general, the plasma fills the region between the electrode 310 and the counter-electrode 330, excluding a “dead zone” near the anode surface.

Optionally, the system 300 can include a magnet assembly 350 which can create a magnetic field of, for example, 50 Gauss to 400 Gauss. The magnet assembly 350 can include a permanent magnet in the platen 120, e.g., located near a top surface 316 of the platen 120. Alternatively, the magnet assembly can include an electromagnet, e.g., an antenna coil wound about the exterior surface of a dielectric (e.g., quartz) portion of the walls 304 of the chamber 103. An RF current is passed through the antenna coil. When operated in a resonance mode with the applied RF power, the antenna coil generates an axial magnetic field within the chamber 103. The magnetic field can confine charged particles, e.g., negative particles such as electrons, to a helical motion.

The chamber 103 defined by the chamber walls 304 can be enclosed in the housing 102. The chamber walls 304 can, for example, allow a vacuum environment to be maintained in a chamber 103 inside the housing 102. A vacuum pump in the housing 102 can be connected to the chamber 103 by a vacuum vent 306 to exhaust gases from within the chamber 103. Process gases, e.g., non-reactive gasses such as argon or helium, or reactive gasses such as and oxygen, can be introduced into chamber 103 via a gas inlet 308. Depending on the processes, different gases can be introduced to the chamber 103.

Operating the system 300 under a vacuum environment may provide quality control for the material formed from processes occurring in the system 300. Nonetheless, the plasma 340 can also be produced under atmospheric pressure.

A dispenser assembly 104, similar to the one shown in FIG. 1A, or in alternative forms as those shown in FIGS. 2B and 2C, can be used to deposit feed material 314 onto over the platen 105. The controller 130 similarly controls a drive system (not shown), e.g., a linear actuator, connected to the dispenser assembly 104. The drive system is configured such that, during operation, the dispenser assembly is movable back and forth parallel to the top surface of the platen 120.

A higher frequency (e.g., more than 50 MHz) drive voltage can be applied to one of the electrodes (either the cathode or the anode), while a lower frequency (e.g., less than 20 MHz) bias voltage can be applied to the other electrode. In general, the higher frequency signal creates the flux of plasma. A higher frequency RF drive voltage creates a higher flux (i.e., more ions and electrons in the plasma). The lower frequency RF bias voltage controls the energy of the ions in the plasma. At low enough frequencies (e.g., 2 MHz), the bias signal can cause the ions in the plasma to have enough energy to vaporize a feed material (e.g., aluminum powder) that is deposited on a substrate (e.g., silicon wafer). In contrast, at a higher frequency bias signal (e.g., 13 MHz), melting of the feed material can occur. Varying the RF frequency and point of application would cause different melting performance of the feed material. Melting performance can determine the recrystallization of the feed material, which could lead to different stresses within the metal and different relaxation behavior.

The system 300 can include laser source 126 to generate a laser beam 124 to scan a layer of feed material 314, as discussed above for FIG. 1A. The laser source 126 can undergo motion relative to the platen 105, or the laser can be deflected, e.g., by a mirror galvanometer. The laser beam 124 can generate sufficient heat to cause the feed material 314 to fuse. The combination of a laser source 126 and the large area background plasma system 302 permits chemical modification, e.g., doping or oxidation, of all of the layer of feed material simultaneously, while still maintaining control of which voxels are fused, e.g., in response to a printing pattern stored in non-transitory computer-readable medium.

The use of plasma allows characteristics of the fused feed material to be easily controlled. For example, the layer of feed material can be doped by selectively implanting ions from the plasma. The doping concentration can be varied layer by layer, e.g., by system 100 or 300, or within a layer of feed material, e.g., by system 100. The implantation of ions can help release or induce point stress in the layer of feed material. Examples of dopants include phosphorous.

The plasma can be biased such that gaps between the powder particles of the feed material and the electrode cause a sufficiently large voltage to be developed on the powder, causing electron or ion bombardment on the feed material. The electrons or ions used in the bombardment can come from the plasma, and be accelerated to the feed material when either a DC or an AC bias is applied on the feed material. Bombardment can be used to treat a layer, to etch material, to chemically alter (e.g., in reactive ion etch) the feed material, to dope the feed material (e.g., to add a nitride layer), or be used for surface treatment.

The systems 100 and 300 can be used for fusing of silicon, silicon oxide or silicon nitride powders, followed by etching of the silicon, silicon oxide or silicon nitride layer.

Referring to either FIG. 1A or 3A, the controller 130 of system 100 or 300 is connected to the various components of the system, e.g., actuators, valves, and voltage sources, to generate signals to those components and coordinate the operation and cause the system to carry out the various functional operations or sequence of steps described above. The controller can be implemented in digital electronic circuitry, or in computer software, firmware, or hardware. For example, the controller can include a processor to execute a computer program as stored in a computer program product, e.g., in a non-transitory machine readable storage medium. Such a computer program (also known as a program, software, software application, or code) can be written in any form of programming language, including compiled or interpreted languages, and it can be deployed in any form, including as a standalone program or as a module, component, subroutine, or other unit suitable for use in a computing environment.

As noted above, the controller 130 can include non-transitory computer readable medium to store a data object, e.g., a computer aided design (CAD)-compatible file, that identifies the pattern in which the feed material should be deposited for each layer. For example, the data object could be a STL-formatted file, a 3D Manufacturing Format (3MF) file, or an Additive Manufacturing File Format (AMF) file. For example, the controller could receive the data object from a remote computer. A processor in the controller 130, e.g., as controlled by firmware or software, can interpret the data object received from the computer to generate the set of signals necessary to control the components of the system to print the specified pattern for each layer.

The processing conditions for additive manufacturing of metals and ceramics are significantly different than those for plastics. For example, in general, metals and ceramics require significantly higher processing temperatures. For example, metals need to processed at temperature on the order of 400° C. or higher, e.g., 700° C. for aluminum. In addition, processing of metal should occur in vacuum environment, e.g., to prevent oxidation. Thus 3D printing techniques for plastic may not be applicable to metal or ceramic processing and equipment may not be equivalent. In addition, the fabrication conditions for large scale-industrial parts can be significantly more stringent.

However, some techniques described here could be applicable to plastic powders. Examples of plastic powders include nylon, acrylonitrile butadiene styrene (ABS), polyurethane, acrylate, epoxy, polyetherimide, polyetheretherketone (PEEK), polyetherketoneketone (PEKK), polystyrene or polyamides.

Certain features that are described in the context of separate embodiments can also be implemented in combination in a single embodiment, and conversely, various features that are described in the context of a single embodiment can also be implemented singly without the other features of that embodiment.

For example, although manufacturing of a part in which the material composition of the part varies spatially is a potential advantage, the system still has other advantages when used to generate parts with uniform material composition, e.g., permitting the combination of formation of materials using plasma and/or gas in conjunction with a laser.

A number of implementations have been described. Nevertheless, it will be understood that various modifications may be made. Accordingly, other implementations are within the scope of the following claims.

1. An additive manufacturing system comprising:
a platen;
a feed material dispenser apparatus configured to deliver a layer of feed material over the platen;
a laser configured to produce a laser beam;
a controller configured to cause the laser beam to fuse the feed material at locations specified by data stored in a computer-readable medium; and
a plasma source configured to produce ions that are directed to impinge substantially the same location on the layer of feed material on the platen as the laser beam.

2. The system of claim 1, wherein the laser source and the plasma source are integrated in a coaxial point laser and plasma source configured such that the laser beam and the ions emerge from the coaxial point laser and plasma source along a common axis.

3. The system of claim 2, wherein the coaxial point laser and plasma source is configured such that the laser beam and the ions emerge in an overlapping region.

4. The system of claim 1, further comprising a drive system configured to raster scan the laser beam across the platen, wherein the controller is configured to control a power of the laser beam at a location on the platen to determine if the feed material at the location fuses.

5. The system of claim 1, further comprising a voltage source electrically connected to the platen to maintain the platen at a first electrical potential to accelerate ions into the feed material.

6. The system of claim 1, wherein the plasma source comprises a conduit having a first end closer to the laser source and a second end closer to the platen, and the laser is positioned to direct the laser beam through the conduit.

7. The system of claim 6, comprising a window at the first end of the conduit to permit passage of the laser beam and block escape of the ions.

8. The system of claim 6, wherein at least the second end of the conduit is conductive, and the plasma source comprises a voltage source connected to the conductive second end of the conduit and configured to apply a voltage sufficient to generate a plasma between the second end of the conduit and the platen.

9. The system of claim 8, wherein the conduit is conductive.

10. The system of claim 6, comprising a pair of electrodes positioned within the conduit, and the plasma source comprises a voltage source connected to the pair of electrodes and configured to apply a voltage sufficient to generate a plasma within the of the conduit.

11. A method of additive manufacturing, comprising:
dispensing a layer of feed material over a platen;
directing a laser beam to heat the feed material at locations specified by data stored in a computer-readable medium; and
directing ionized gas to impinge substantially the same location on the layer of feed material on the platen as the laser beam.

12. The method of claim 11, comprising directing the laser beam and the ionized gas along a common axis.

13. The method of claim 11, comprising raster scanning the laser beam across the platen and controlling a power of the laser beam at a location to determine if the feed material at the location fuses.

14. The method of claim 11, comprising raster scanning a source of the ionized gas across the platen and controlling the flow or composition of ionized gas from the source to control a chemical composition of the feed material within the layer of the feed material.

15. The method of claim 11, wherein the ionized gas is directed at a region of the layer of feed material corresponding to a surface of an object being fabricated to form a coating of different composition on the object.

16. The method of claim 11, wherein the feed material comprises titanium powder and the ionized comprises nitrogen.

17. The method of claim 11, comprising controlling a density of ionized gas to control a surface roughness of the feed material as the feed material is being fused.

18. The method of claim 11, comprising accelerating the ions sufficiently to remove feed material.

19. The system of claim 1, wherein the controller is coupled to the plasma source and configured to cause the ions to be directed at a region of the layer of feed material corresponding to a surface of an object being fabricated to form a coating of different composition on the object.

20. The system of claim 1, comprising an RF bias source coupled to the platen and configured to accelerate the ions onto the feed material.
